(19) United States
(12) Patent Application Publication
(10) Pub. No.: US 2025/0334962 A1
(43) Pub. Date: Oct. 30, 2025

(54) INTEGRATED CONTROL APPARATUS FOR VEHICLE AND DEBUGGING CONTROL METHOD OF THE SAME

(71) Applicant: HYUNDAI MOBIS CO., LTD., Seoul (KR)

(72) Inventors: Kwangseol KO, Plymouth, MI (US); Justin SOHN, Plymouth, MI (US); Alicia TAN, Plymouth, MI (US); Jaepil LEE, Yongin-si (KR)

(73) Assignee: HYUNDAI MOBIS CO., LTD., Seoul (KR)

(21) Appl. No.: 18/650,450

(22) Filed: Apr. 30, 2024

(51) Int. Cl. G05B 23/02; B60W 50/02; B60W 50/04; G06F 21/62

(52) U.S. Cl. CPC G05B 23/0267; B60W 50/0205; B60W 50/04; G06F 21/62; B60W 2756/10

(57) ABSTRACT

An integrated control apparatus for a vehicle according to an embodiment of the present disclosure includes a software component mapped onto each of a plurality of electronic control units (ECUs) for vehicle control and processing data of a corresponding ECU, and an aggregator that collects and analyzes diagnostic data regarding the ECU from the software component, generates error information about the corresponding ECU based on a predefined decoding table when an error occurs in the ECU, and transmits the error information to an external debugging apparatus.

### TECHNICAL FIELD

The present disclosure relates to an integrated control apparatus for a vehicle, and a debugging control method of the same.

### BACKGROUND

Currently, due to the increased demand for automotive performance, fuel efficiency, and safety, the functions of electronic control units (ECUs) have become more extensive and complex. Moreover, as automotive technology advances, more functions and systems are being integrated into an ECU, including powertrain, brakes, suspension, and infotainment systems. These functions require great processing power, great memory capacity, and advanced algorithms to keep a vehicle running smoothly and efficiently.

Typically, a car company develops a basic platform that is applied to a vehicle, and each ECU used for a specific function of a car uses a model for developing platforms in different regions or countries.

Although this approach to development is cost-effective, it requires employees to possess extensive knowledge. Furthermore, when platforms for different functions are developed in different regions or countries, effective communication between developers needs to be facilitated to minimize development time. Because each developer uses different technologies, it may be challenging to develop for each platform.

Accordingly, to set and develop open industry standards for vehicle ECUs, related companies are collaborating to propose software architecture standards such as Automotive Open System Architecture (AUTOSAR).

The AUTOSAR refers to a standardization and execution environment for software for vehicles, and provides an architecture and application programming interface (API) for automotive software. Accordingly, the ECUs of a vehicle applying the AUTOSAR standard may communicate with each other through an environment called a communication bus. As the number of ECUs increases, the size and number of data to communicate with each other also increases.

In the meantime, in the vehicle industry, when a failure occurs in a process of developing and maintaining ECU, it is difficult to quickly identify and resolve the cause of the failure due to limited physical access and connection issues between the ECU installed in the vehicle and external devices, and multiple processes running simultaneously. Besides, cyber-security regulations may restrict external access to the ECU, and communication channels may be blocked after certain steps.

Accordingly, when an AUTOSAR platform fails, it is necessary to develop solutions to resolve the failure quickly and efficiently.

### SUMMARY

The present disclosure has been made to solve the above-mentioned problems occurring in the prior art while advantages achieved by the prior art are maintained intact.

An aspect of the present disclosure provides an integrated control apparatus for a vehicle that may quickly respond to problem situations by quickly identifying error causes without removing an ECU from the vehicle when an error occurs in the ECU of the vehicle, and debugging the error based on the identified result, and a debugging control method of the same.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an integrated control apparatus for a vehicle includes a software component mapped onto each of a plurality of electronic control units (ECUs) for vehicle control and processing data of a corresponding ECU, and an aggregator that collects and analyzes diagnostic data regarding the ECU from the software component, generates error information about the corresponding ECU based on a predefined decoding table when an error occurs in the ECU, and transmits the error information to an external debugging apparatus.

In an embodiment, in the predefined decoding table, a process ID for a process in which an error occurs in the ECU, an error ID for the error that occurs in the process, and an error code are defined for each cause of the error.

In an embodiment, the error code is defined as a five-digit code including a one-digit process ID, a two-digit error ID, and a two-digit error cause.

In an embodiment, each of the process ID, the error ID, and the error cause is defined by one of numbers from 0 to 9 and letters ‘A’, ‘C’, ‘E’, or ‘F’ for each digit, depending on a process type, an error type, or an error cause.

In an embodiment, the external debugging apparatus includes a debugging board connected to the integrated control apparatus for the vehicle through a communication cable and having a 7-segment display that displays a five-digit error code received through the communication cable.

In an embodiment, the external debugging apparatus further includes at least one of an external tool including a display, or external diagnostic equipment.

In an embodiment, the aggregator is configured to collect error data regarding the ECU, in which the error occurs, from the software component, and sets security of the error data by using a security key generated with unique information about the ECU.

In an embodiment, the integrated control apparatus further includes a diagnostic communication module that receives the error data, of which the security is set, from the aggregator, stores the error data in a memory cell corresponding to each diagnostic ID, and provides the stored error data through validity verification of the security key entered from an external device when there is a request from the external device.

In an embodiment, the diagnostic communication module is configured to request validity verification for the security key, which is entered from the external device, from the aggregator, when there is a request for the error data stored in the memory cell from the external device, and provides the error data to the external device when verification is completed.

According to an aspect of the present disclosure, a debugging control method of an integrated control apparatus for a vehicle includes collecting and analyzing, by an aggregator, diagnostic data regarding an ECU from a software component that is mapped onto each of a plurality of ECUs for vehicle control, and configured to process data of a corresponding ECU, and generating, by the aggregator, error information about the corresponding ECU based on a predefined decoding table when an error occurs in the ECU, and transmitting the error information to an external debugging apparatus.

### BRIEF DESCRIPTION OF THE DRAWINGS

The above and other objects, features and advantages of the present disclosure will be more apparent from the following detailed description taken in conjunction with the accompanying drawings:

FIG. 1 is a diagram showing a hardware structure of an integrated control apparatus, according to an embodiment of the present disclosure;

FIG. 2 is a diagram showing a software structure of an integrated control apparatus, according to an embodiment of the present disclosure;

FIG. 3 is a diagram showing a connection structure between an integrated control apparatus and an external tool, according to an embodiment of the present disclosure;

FIG. 4 is a diagram showing a decoding table for an error code, according to an embodiment of the present disclosure; and

FIGS. 5 to 8 are diagrams illustrating operational flows of a debugging control method of an integrated control apparatus, according to an embodiment of the present disclosure.

### DETAILED DESCRIPTION

Hereinafter, some embodiments of the present disclosure will be described in detail with reference to the accompanying drawings. In adding reference numerals to components of each drawing, it should be noted that the same components include the same reference numerals, although they are indicated on another drawing. In describing embodiments of the present disclosure, detailed descriptions associated with well-known functions or configurations will be omitted when they may make subject matters of the present disclosure unnecessarily obscure.

In describing components of embodiments of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein.

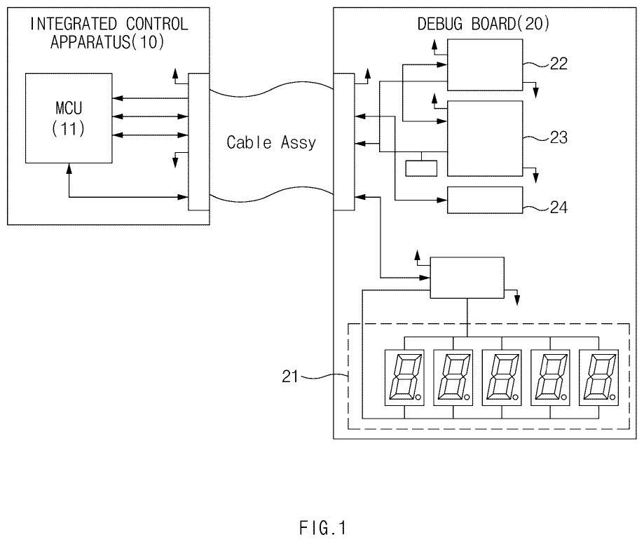

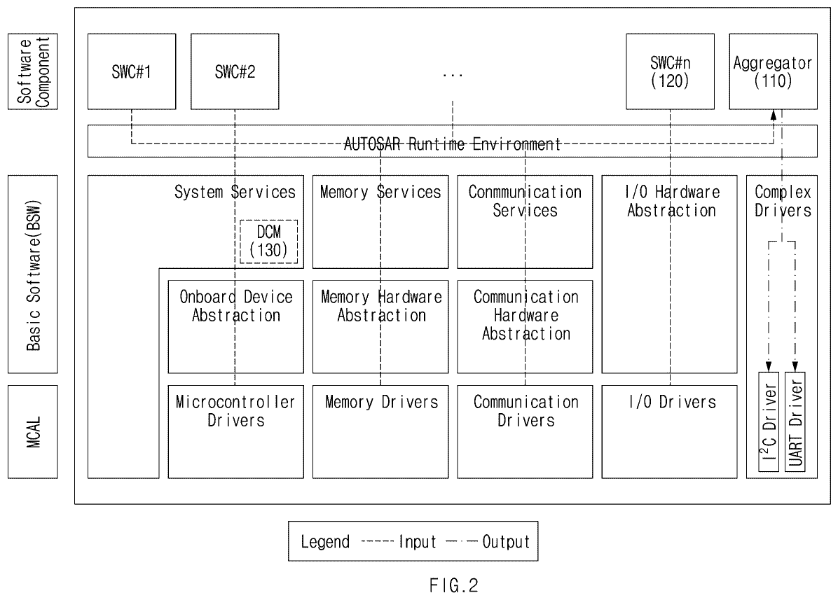

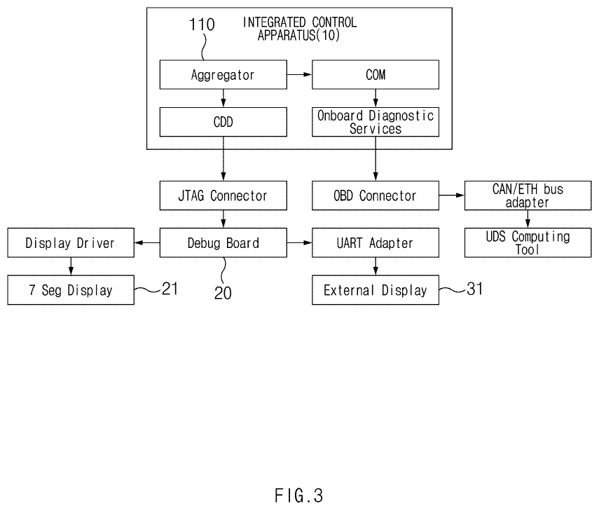

FIG. 1 is a diagram showing a hardware structure of an integrated control apparatus, according to an embodiment of the present disclosure. FIG. 2 is a diagram showing a software structure of an integrated control apparatus, according to an embodiment of the present disclosure. FIG. 3 is a diagram showing a connection structure between an integrated control apparatus and an external tool, according to an embodiment of the present disclosure.

First of all, referring to FIG. 1, a vehicle includes devices such as an engine, an automatic transmission, a braking system (ABS), and a steering system, and an integrated control apparatus 10 that controls the devices. ECUs may be installed in the integrated control apparatus 10. Moreover, the integrated control apparatus 10 for a vehicle may be additionally connected to an ECU for providing more functions as intelligent services increase. The integrated control apparatus 10 makes it possible to provide combined services through interworking between connected ECUs.

The ECUs may be installed on a main board of the integrated control apparatus 10. A micro control unit (MCU) 11 that controls the ECUs may be installed together.

The ECUs are manufactured by several related companies. Accordingly, when installing and connecting the ECUs to the integrated control apparatus 10 of the vehicle, the ECUs are debugged to check errors in operating processes.

Accordingly, a debug board 20 for debugging ECUs may be connected to the integrated control apparatus 10.

The debug board 20 may be connected to the integrated control apparatus 10 by using a 12-pin cable. In this case, when an error occurs in a system and/or process, the integrated control apparatus 10 may transmit error information to the debug board 20 connected through the 12-pin cable.

Here, the debug board 20 may be equipped with a 7-segment display 21. When the error information is received from the integrated control apparatus 10, the debug board 20 may display an error code for the corresponding error on the 7-segment display 21. Accordingly, the user may determine the type and cause of an error that occurred in software of the electronic control apparatus from the error code displayed on the 7-segment display 21 of the debug board 20.

Besides, the debug board 20 may be additionally equipped with connection means 22 to 24 for connecting other tools necessary for debugging. For example, the debug board 20 may be equipped with the connection means 22 to 24, such as Trace32, MiniProg4, and UART. Here, Trace32 may be used to analyze and debug a source code; MiniProg4 may be used for software flashing of the MCU 11; and, UART may be used to display logs on an external tool 30 such as a laptop.

The software of the integrated control apparatus 10 may be composed of an AUTOSAR-based software structure as shown in FIG. 2.

Referring to FIG. 2, the AUTOSAR-based software structure may have a hierarchical structure segmented into a basic software (BSW) layer, an application software layer, and a run-time environment (RTE).

The BSW refers to a standardized software layer that provides services necessary for a software component SWC 120 to perform tasks, and provides services related to input/output, memory, or communication to the software component SWC 120.

The BSW layer may include a module that allows various services for application software along with providing ECU-related abstraction. For example, a microcontroller abstraction layer (MCAL) is a module that directly accesses the MCU and allows other layers to communicate with the MCU.

The BSW layer may include a services layer, an ECU abstraction layer, a microcontroller abstraction layer, and a complex driver.

Here, the service layer, which refers to a layer including communication, services, and OS blocks, may abstract the ECU and hardware and may provide services for application programs and BSW layers to its upper layer. In other words, the service layer may perform service functions such as memory, communication network, and systems. The service layer may provide services for application programs and BSW to its upper layer.

The communication network service of the service layer provides a unified communication method to the RTE. The communication network service may be composed of the software component SWC 120 that provides functions of vehicle network communication such as CAN, LIN, or FlexRay, a communication driver interface, such as communication hardware abstraction, and a vehicle network interface for communication between different applications.

The memory service of the service layer may provide functions of reading and writing to various memories, and may be composed of the software component SWC 120 that provides functions such as management of a non-volatile memory for reading/writing other memory services, location and property abstraction of a memory, or the like.

In the meantime, the ECU abstraction layer and the microcontroller abstraction layer are parts changed depending on hardware, and are changed to appropriate software whenever the hardware is changed. In other words, the ECU abstraction layer may vary depending on an ECU circuit. The microcontroller abstraction layer may vary depending on the used microcontroller (MCU).

Moreover, the microcontroller abstraction layer processes direct access to peripherals, internal/external tools, memory, and the like included in the actual hardware.

The microcontroller abstraction layer is a hardware-dependent part, and is composed of a communication driver of a data link layer of OSI, an analog and digital I/O driver such as ADC, PWM, and DIO, a memory driver such as EEPROM and Flash, and a device driver area of a peripheral microcontroller.

In the meantime, when special functions are developed, the complex driver may be used when the application software layer needs direct access to the hardware.

The RTE supports data exchange and communication and separates software and hardware. In other words, the RTE serves as a communication bridge between the application software layer and the lower software component SWC 120, and supports communication between the software component SWC 120 and other components through various mapping processes with the ECU depending on the needs of the software component SWC 120.

As such, the communication between the software component SWC 120 and other components may be performed through a virtual network called a virtual function bus (VFB). The software components SWC 120 assigned to the ECU may perform necessary tasks by exchanging information with each other through the RTE present in each ECU. Because the software component SWC 120, which is implemented based on the RTE, has unique communication constraints depending on the type of application, it may be configured to satisfy these constraints.

The application software layer refers to a layer composed of the software components SWC 120 mapped onto the ECU, and communicates with all resources of the lower layer through RTE. The software components SWC 120 may be mapped onto a specific ECU.

The software component SWC 120 may implement each application software function and may exchange data as a basic unit mapped onto the ECU. The software component SWC 120 needs to exchange data through a virtual bus such as the RTE. The data exchange between multi-cores is accomplished through Inter OS application Communication (IOC). Because the software component SWC 120 is incapable of directly accessing hardware or a BSW module without going through the RTE, the software component SWC 120 may configure runnables to perform functions of the software component SWC 120, and may process the scheduling of the software component SWC 120 in this way.

The AUTOSAR platform having a software structure provides debugging information (i.e., diagnostic information) about the system to the aggregator 110.

Here, in the AUTOSAR-based software structure, the service layer may further include a diagnostic communication module DCM 130 that supports diagnostic communication between the ECU and external diagnostic equipment for vehicle diagnosis.

The diagnostic communication module DCM 130 corresponds to a communication service in the service layer and processes service processing and responses to a diagnostic service request. The diagnostic communication module DCM 130 manages data flow and status in diagnostic communication and processes an operation according to diagnostic requests.

In this case, the diagnostic communication module DCM 130 supports a unified diagnostic service (UDS) and an on-board diagnostics (OBD) protocol commonly used in vehicle diagnostic communication. A service table is defined in these protocols. Accordingly, whether services defined in the UDS are supported may be set.

The aggregator 110 may identify and analyze debugging information provided by the AUTOSAR platform and may collect debugging information related to vehicle software applications and hardware (HW). For example, the aggregator 110 may provide the collected debugging information to the debug board 20.

When an error occurs in the software component SWC 120, the aggregator 110 may process the error and may transmit the processed result to the external tool 30 through a communication channel. In this case, the aggregator 110 may transmit error information such as an error code by using communication channels such as 12C, SPI, UART, and the like. The error information may include debugging information generated based on information collected from each process and HW module, which have an error.

Referring to FIGS. 1 and 3, the aggregator 110 may transmit the error information to the debug board 20 connected to the outside. In this case, the debug board 20 may display the error information, which is received from the aggregator 110, on the 7-segment display 21. For example, the error information may include a five-digit error code, and this error code may consist of all pieces of information in the system.

Accordingly, a user (or a developer) may debug errors occurring in the process and/or HW module by performing decoding by using a predefined decoding table based on information displayed in the 7-segment display 21.

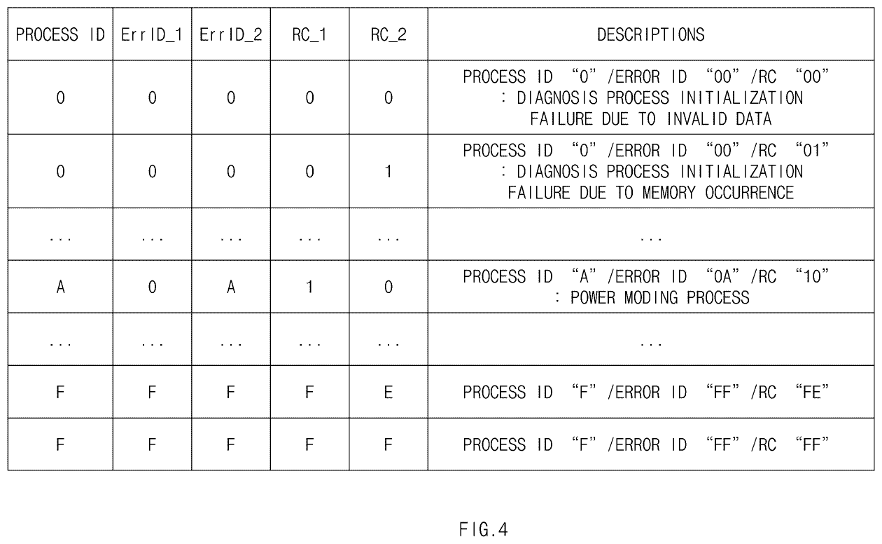

FIG. 4 is a diagram showing a decoding table for an error code, according to an embodiment of the present disclosure. Referring to FIG. 4, the predefined decoding table for each system error is defined for a five-digit error code. The five-digit error code may be composed of information such as process ID (one digit), error ID (two digits), and error cause (two digits).

The process ID may be the first code among the five-digit error codes and may be expressed in hexadecimal. However, letter ‘B’ is similar to number ‘8’, and letter ‘D’ is similar to number ‘0’. To avoid confusion, the process ID may be represented by any of numbers 0 to 9 or letters A, C, E, or F, except for B and D.

The error ID ErrID may be the second code ErrID_1 and the third code ErrID_2 among the five-digit error code, and, like the process ID, may be represented by any of the numbers 0 to 9 or the letters A, C, E, or F, except for B and D.

The error cause RC may be the fourth code RC_1 and the fifth code RC_2 among the five-digit error code, and, like the process ID, may be represented by any of the numbers 0 to 9 or the letters A, C, E, or F, except for B and D.

Accordingly, the predefined decoding table defines an error code obtained by combining the process ID, the error ID, and the error cause.

For example, the error code “00000” is process ID “0”, error ID “00”, and RC “00”, and means ‘diagnosis process initialization failure due to invalid data.’

Moreover, the error code “00001” means process ID “0”, error ID “00”, and RC “01”, meaning ‘diagnosis process initialization failure due to memory occurrence’.

Furthermore, the error code “A0A10” means process ID “A”, error ID “OA”, and RC “10”, which means an error in a power moding process.

In this way, the five-digit error code may be generated according to the process ID, the error ID, and the error cause.

In this case, 145 (=537,824) error codes may be generated for 14 processes installed in the ECU.

Accordingly, a user may identify system errors from the five-digit error code displayed on the 7-segment display 21.

In the meantime, the aggregator 110 may transmit and display text to the external display 31, such as a laptop, by using the UART communication protocol. Furthermore, when a separate debugging tool is connected, the aggregator 110 may transmit logs to a UDS computing tool by using an OBD connector.

In this case, information transmitted by the aggregator 110 may be configured to be supplemented with a security key to prevent unauthorized access. For example, the aggregator 110 may generate a security key by applying the vehicle identify number (VIN) and additional security matters.

As such, it is possible to quickly identify the cause of the error and respond to the error by collecting diagnostic information according to the occurrence of an error in the ECU through the aggregator 110 without removing the ECU from a vehicle, when the debug board 20, the external display 31, and/or the debugging tool is used.

The operational flow of the electronic control apparatus according to an embodiment of the present disclosure configured as described above will be described in more detail as follows.

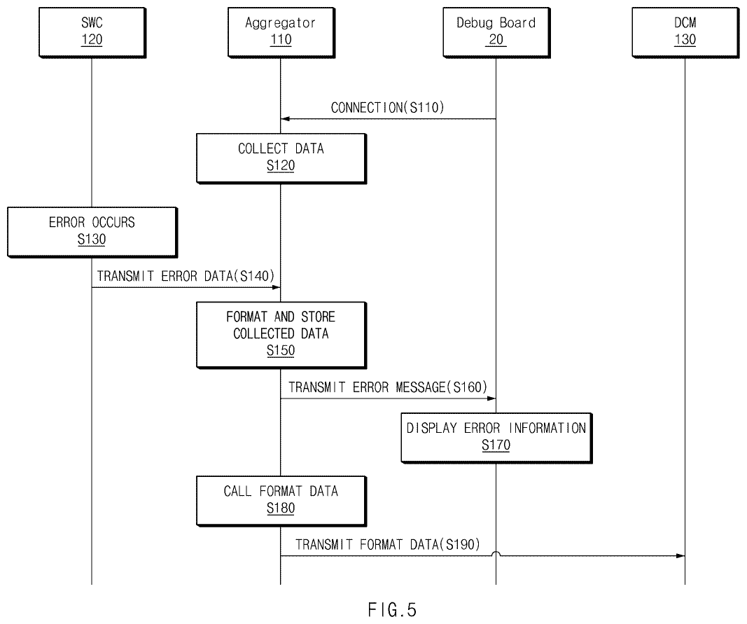

FIGS. 5 to 8 are diagrams illustrating operational flows of a debugging control method of an integrated control apparatus, according to an embodiment of the present disclosure.

First of all, FIG. 5 shows processing operations when an error occurs in an ECU.

Referring to FIG. 5, when the debug board 20 is connected (S110), the aggregator 110 of the integrated control apparatus 10 collects diagnostic data (S120).

When an error occurs in the software component SWC 120 (S130) in a process of the aggregator 110 collecting the diagnostic data, the software component SWC 120 may transmit error data to the aggregator 110 (S140).

Accordingly, the aggregator 110 formats and stores error data (e.g., data in 6 Bytes format) collected from the software component SWC 120 in a predetermined format (S150).

When the data collected from the software component SWC 120 includes the error data, the aggregator 110 transmits an error message to the debug board 20 connected in ‘S110’ (S160). Here, the error message may include a five-digit error code for error information of the software component SWC 120.

Accordingly, when the error information of the software component SWC 120 is received from the aggregator 110, the debug board 20 displays the corresponding error information (e.g., a five-digit error code) on a display (S170). Here, the display of the debug board 20 may be the 7-segment display 21. The five-digit error code for error information of the software component SWC 120 is described with reference to an embodiment of FIG. 4. Accordingly, a user may identify an exact location, at which the error occurs, from the error code displayed in the 7-segment display 21.

Furthermore, the aggregator 110 may call format data stored in ‘S150’ (S180) and may transmit the format data to the diagnostic communication module DCM 130 (S190). In this case, before transmitting the format data in ‘S190’, the aggregator 110 may prevent unauthorized access to data by adding a unique security key of an ECU to the corresponding format data.

Accordingly, the format data transmitted to the diagnostic communication module DCM 130 may be stored in a memory cell corresponding to a diagnostic ID (DID) in the diagnostic communication module DCM 130.

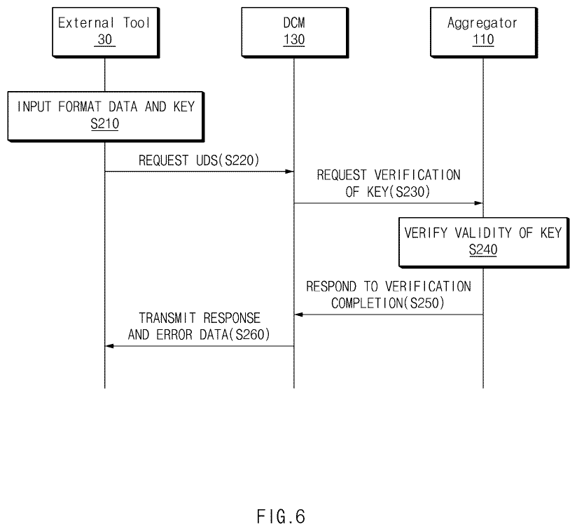

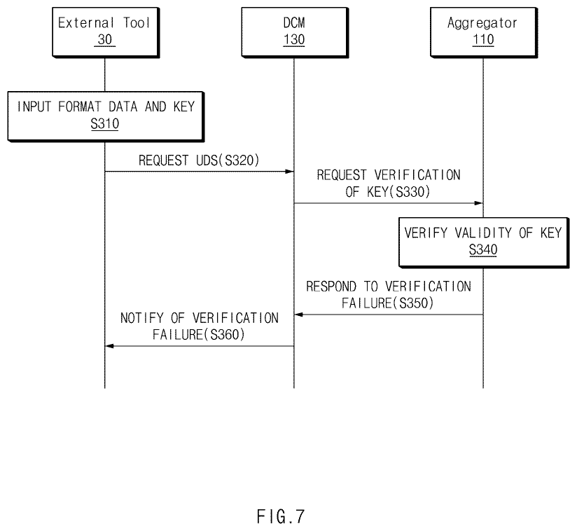

FIGS. 6 and 7 show communication operations between an integrated control apparatus and an external tool.

A user may employ the external tool 30 to search for data from memory cells of the diagnostic communication module DCM 130 at which error data is stored.

Referring to FIG. 6, when the external tool 30 inputs format data and a key (S210) and requests service to the diagnostic communication module DCM 130 through a UDS protocol (S220), the diagnostic communication module DCM 130 make a request for the verification of the key transmitted from the external tool 30 to the aggregator 110 (S230).

Accordingly, the aggregator 110 verifies the validity of the key at the request in ‘S230’ (S240), responds to the result, and transmits the response to the diagnostic communication module DCM 130 (S250). In this case, when it is identified that the key is valid in ‘S240’, the aggregator 110 may determine that key verification is successful, and may transmit a response corresponding to verification completion to the diagnostic communication module DCM 130 in ‘S250’.

When the response to verification completion is received in ‘S250’, the diagnostic communication module DCM 130 calls error data from the customized DID, and also transmits the error data while transmitting the response to the external tool 30 (S260).

Accordingly, the user may identify the error data through the external tool 30 and may identify the cause of the error through the error data.

In the meantime, referring to FIG. 7, when the external tool 30 inputs format data and a key (S310) and requests service through a UDS protocol to the diagnostic communication module DCM 130 (S320), the diagnostic communication module DCM 130 requests verification of a key transmitted from the external tool 30 to the aggregator 110 (S330).

Accordingly, the aggregator 110 verifies the validity of the key at the request in ‘S330’ (S340), responds to the result, and transmits the response to the diagnostic communication module DCM 130 (S350). In this case, when it is identified that the key is not valid in ‘S340’, the aggregator 110 may determine that key verification fails, and may transmit a response corresponding to verification failure to the diagnostic communication module DCM 130 in ‘S350’.

When the response to verification failure is received in ‘S350’, the diagnostic communication module DCM 130 notifies the external tool 30 of the result of verification failure of the key (S360).

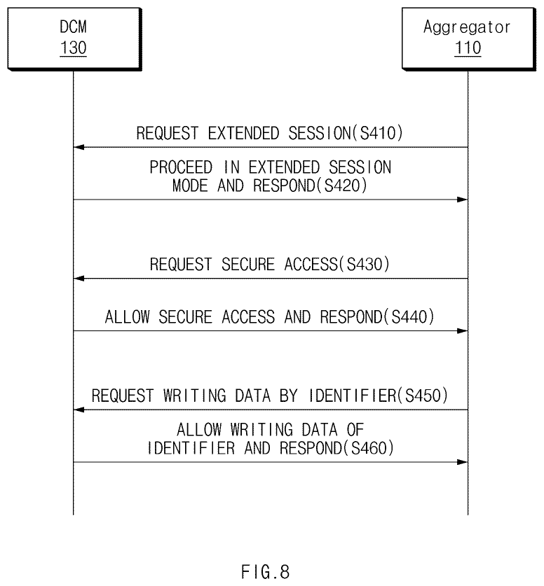

FIG. 8 shows a communication operation between the aggregator 110 and the diagnostic communication module DCM 130, and shows a flow of operations in which the aggregator 110 records data in a memory cell corresponding to a DID in the diagnostic communication module DCM 130.

Referring to FIG. 8, to record data in a memory cell corresponding to the DID of the diagnostic communication module DCM 130, the aggregator 110 makes a request for an extended session to the diagnostic communication module DCM 130 (S410), and proceeds in the determined session mode by responding to the request in ‘S410’ (S420).

Afterward, the aggregator 110 make a request for secure access to the diagnostic communication module DCM 130 (S430), and the diagnostic communication module DCM 130 allows the secure access to the aggregator 110 by responding to the request in ‘S430’ (S440).

When the secure access to the diagnostic communication module DCM 130 is allowed in ‘S440’, the aggregator 110 requests the diagnostic communication module DCM 130 to write data for each identifier by using data and a security key (S450) by calling the data collected and stored in ‘S150’ of FIG. 5 and transmitting the data to the diagnostic communication module DCM 130 along with the security key.

Accordingly, the diagnostic communication module DCM 130 writes the data and the security key for each identifier at the request in ‘S450’, responds to the result and transmits the result to the aggregator 110 (S460).

According to an embodiment of the present disclosure, the integrated control apparatus may be implemented as processor-readable code on a processor-readable recording medium provided in an ECU and/or vehicle, and a debugging control method of the same. The processor-readable recording medium includes all types of recording devices that store data capable of being read by the processor. Examples of the processor-readable recording medium include a read-only memory (ROM), a random access memory (RAM), CD-ROM, a magnetic tape, and a floppy disk, an optical data storage device, and may also be implemented in the form of a carrier wave, such as transmission through the Internet. Also, in the processor-readable recording medium, a code, which a computer may read out, may be stored and executed in a computing system connected over a network in a distributed manner.

The above description is merely an example of the technical idea of the present disclosure, and various modifications and modifications may be made by one skilled in the art without departing from the essential characteristic of the present disclosure.

Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

According to an embodiment of the present disclosure, an integrated control apparatus for a vehicle may quickly respond to problem situations by quickly identifying error causes without removing an ECU from the vehicle when an error occurs in the ECU of the vehicle, and debugging the error based on the identified result.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An integrated control apparatus for a vehicle, the integrated control apparatus comprising:
a software component mapped onto each of a plurality of electronic control units (ECUs) for vehicle control and configured to process data of a corresponding ECU among the plurality of ECUs; and
an aggregator configured to collect and analyze diagnostic data regarding the ECU from the software component, to generate error information about the corresponding ECU based on a predefined decoding table in response that an error occurs in the ECU, and to transmit the error information to an external debugging apparatus.

2. The integrated control apparatus of claim 1, wherein, in the predefined decoding table, a process ID for a process in which the error occurs in the ECU, an error ID for the error that occurs in the process, and an error code are defined for each error cause.

3. The integrated control apparatus of claim 2, wherein the error code is defined as a five-digit code including a one-digit process ID, a two-digit error ID, and a two-digit error cause.

4. The integrated control apparatus of claim 3, wherein each of the process ID, the error ID, and the error cause is defined by one of numbers from 0 to 9 and letters ‘A’, ‘C’, ‘E’, or ‘F’ for each digit, depending on a process type, an error type, or the error cause.

5. The integrated control apparatus of claim 3, wherein the external debugging apparatus includes a debugging board connected to the integrated control apparatus for the vehicle through a communication cable and having a 7-segment display that displays a five-digit error code received through the communication cable.

6. The integrated control apparatus of claim 1, wherein the external debugging apparatus further includes at least one of an external tool including a display, or external diagnostic equipment.

7. The integrated control apparatus of claim 1, wherein the aggregator is configured to collect error data regarding the ECU, in which the error occurs, from the software component, and to set security of the error data by using a security key generated with unique information about the ECU.

8. The integrated control apparatus of claim 7, further comprising:
a diagnostic communication module configured to receive the error data, of which the security is set, from the aggregator, to store the error data in a memory cell corresponding to each diagnostic ID, and to provide the stored error data through validity verification of the security key entered from an external device in response that there is a request from the external device.

9. The integrated control apparatus of claim 8, wherein the diagnostic communication module is configured to request validity verification for the security key, which is entered from the external device, to the aggregator in response that there is a request for the error data stored in the memory cell from the external device, and to provide the error data to the external device in response that verification is completed.

10. A debugging control method of an integrated control apparatus for a vehicle, the method comprising:
collecting and analyzing, by an aggregator, diagnostic data regarding an ECU from a software component that is mapped onto each of a plurality of ECUs for vehicle control, and configured to process data of a corresponding ECU among the plurality of ECUs; and
generating, by the aggregator, error information about the corresponding ECU based on a predefined decoding table in response that an error occurs in the ECU, and transmitting the error information to an external debugging apparatus.

11. The debugging control method of claim 10, wherein, in the predefined decoding table, a process ID for a process in which the error occurs in the ECU, an error ID for the error that occurs in the process, and an error code are defined for each error cause.

12. The debugging control method of claim 11, wherein the error code is defined as a five-digit code including a one-digit process ID, a two-digit error ID, and a two-digit error cause.

13. The debugging control method of claim 12, wherein each of the process ID, the error ID, and the error cause is defined by one of numbers from 0 to 9 and letters ‘A’, ‘C’, ‘E’, or ‘F’ for each digit, depending on a process type, an error type, or the error cause.

14. The debugging control method of claim 10, wherein the aggregator is configured to collect error data regarding the ECU, in which the error occurs, from the software component, and to set security of the error data by using a security key generated with unique information about the ECU.

15. The debugging control method of claim 14, further comprising:
receiving, by a diagnostic communication module, the error data, of which the security is set, from the aggregator, storing, by the diagnostic communication module, the error data in a memory cell corresponding to each diagnostic ID, and providing, by the diagnostic communication module, the stored error data through validity verification of the security key entered from an external device in response that there is a request from the external device.

16. The debugging control method of claim 15, further comprising:
requesting, by the diagnostic communication module, validity verification for the security key, which is entered from the external device, to the aggregator in response that there is a request for the error data stored in the memory cell from the external device, and providing, by the diagnostic communication module, the error data to the external device in response that verification is completed.
